(19) United States
(12) Patent Application Publication
(10) Pub. No.: US 2016/0200424 A1
(43) Pub. Date: Jul. 14, 2016

(54) TIRE SPINNING ASSEMBLY

(71) Applicant: Gary Mabie, Jacksonville, AL (US)

(72) Inventor: Gary Mabie, Jacksonville, AL (US)

(21) Appl. No.: 14/592,908

(22) Filed: Jan. 9, 2015

(51) Int. Cl. B64C 25/40; B64C 25/36

(52) U.S. Cl. CPC B64C 25/40; B64C 25/36

(57) ABSTRACT

A tire spinning assembly for includes a tire that may be coupled to landing gear of an aircraft. A plurality of vanes is coupled to the tire. The vanes are frictionally engaged by air when the landing gear are deployed thereby rotating the tire. The vanes are oriented such that the tire is rotated in a direction and a speed corresponding to a direction and a speed traveled by the aircraft. The rotation of the tire reduces an amount of friction between the outer wall and ground when the aircraft lands.

### BACKGROUND OF THE DISCLOSURE

1. Field of the Disclosure

The disclosure relates to spinning devices and more particularly pertains to a new spinning device for rotating an aircraft tire prior to landing.

### SUMMARY OF THE DISCLOSURE

An embodiment of the disclosure meets the needs presented above by generally comprising a tire that may be coupled to landing gear of an aircraft. A plurality of vanes is coupled to the tire. The vanes are frictionally engaged by air when the landing gear are deployed thereby rotating the tire. The vanes are oriented such that the tire is rotated in a direction and a speed corresponding to a direction and a speed traveled by the aircraft. The rotation of the tire reduces an amount of friction between the outer wall and ground when the aircraft lands.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a tire spinning assembly according to an embodiment of the disclosure.

FIG. 2 is a perspective view of an alternative embodiment of the disclosure.

FIG. 3 is a in-use view of an embodiment of the disclosure.

### DESCRIPTION OF THE PREFERRED EMBODIMENT

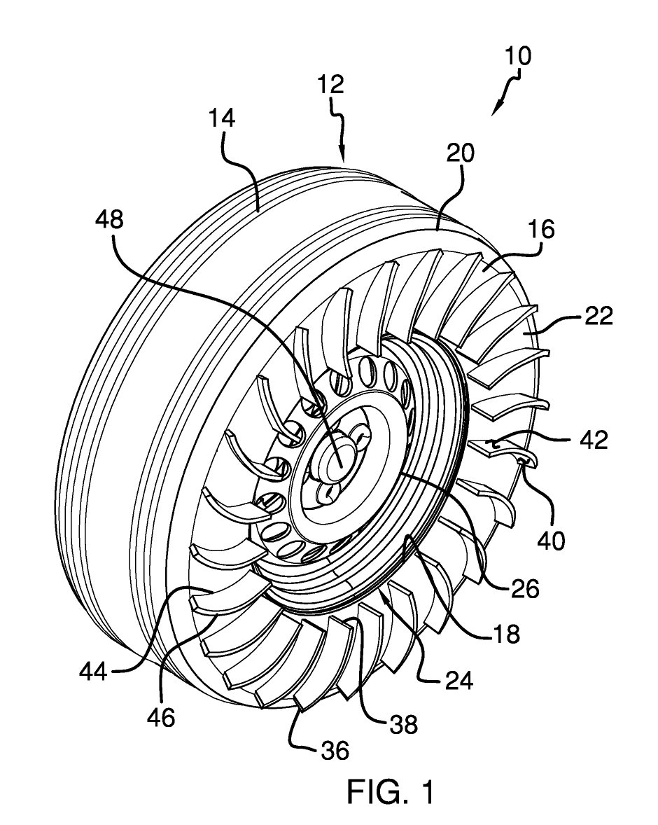

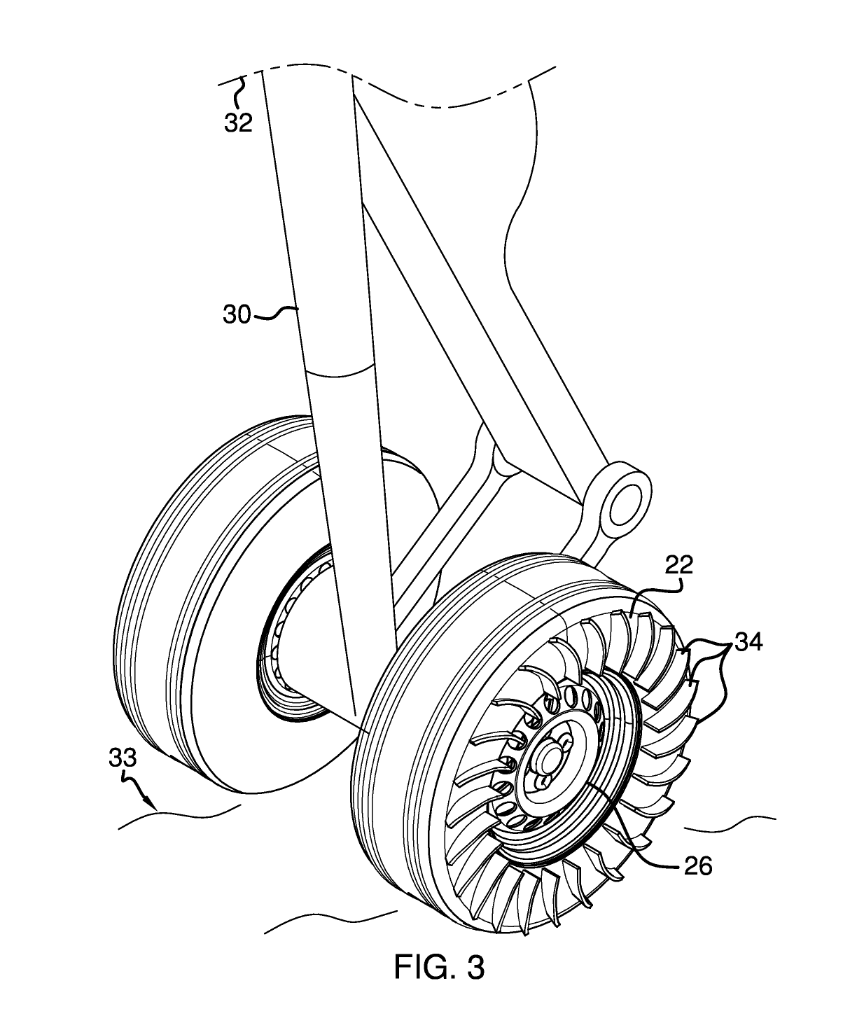

With reference now to the drawings, and in particular to FIGS. 1 through 3 thereof, a new spinning device embodying the principles and concepts of an embodiment of the disclosure and generally designated by the reference numeral 10 will be described.

As best illustrated in FIGS. 1 through 3, the tire spinning assembly 10 generally comprises a tire 12 that has an outer wall 14 and a peripheral wall 16 extending inwardly therefrom. The peripheral wall 16 has an inner edge 18, an outer edge 20 and a first lateral side 22 extending therebetween. The inner edge 18 defines an opening 24 in the tire 12. The outer wall 14 is arcuate such that the tire 12 has a donut shape.

The tire 12 is mounted on a wheel 26. The inner edge 18 abuts an exterior edge 28 of the wheel 26 such that the wheel 26 is positioned within the opening 24. The wheel 26 may be an aircraft wheel of any conventional design. The wheel 26 may be coupled to landing gear 30 of an aircraft 32. The first lateral side 22 is exposed with respect to the landing gear 30. The outer wall 14 engages ground 32 thereby supporting the aircraft 32 above ground 33.

A plurality of vanes 34 each has a first end 36, a second end 38, a front surface 40 and a back surface 42 each extending between the first end 36 and the second end 38. Each of the vanes 34 additionally has a first lateral edge 44 and a second lateral edge 46. The first end 36 has a height that is greater than a height of the second end 38.

The first lateral edge 44 is coupled to the first lateral side 22. The vanes 34 extend outwardly from the first lateral side 22. The first end 36 is positioned adjacent to the outer edge 20. The second end 38 is positioned adjacent to the inner edge 18. The vanes 34 are distributed around the first lateral side 22.

The front surface 40 and the back surface 42 are convexly curvilinear between the first end 36 and the second end 38. The vanes 34 are frictionally engaged by air when the landing gear 30 is deployed while the aircraft 32 is in flight. The friction of air on the vanes 34 causes the tire 12 to rotate. The vanes 34 are oriented such that the tire 12 is rotated in a direction and a speed corresponding to a direction and a speed traveled by the aircraft 32. The rotation of the tire 12 reduces an amount of friction between the outer wall 14 and ground when the aircraft 32 lands.

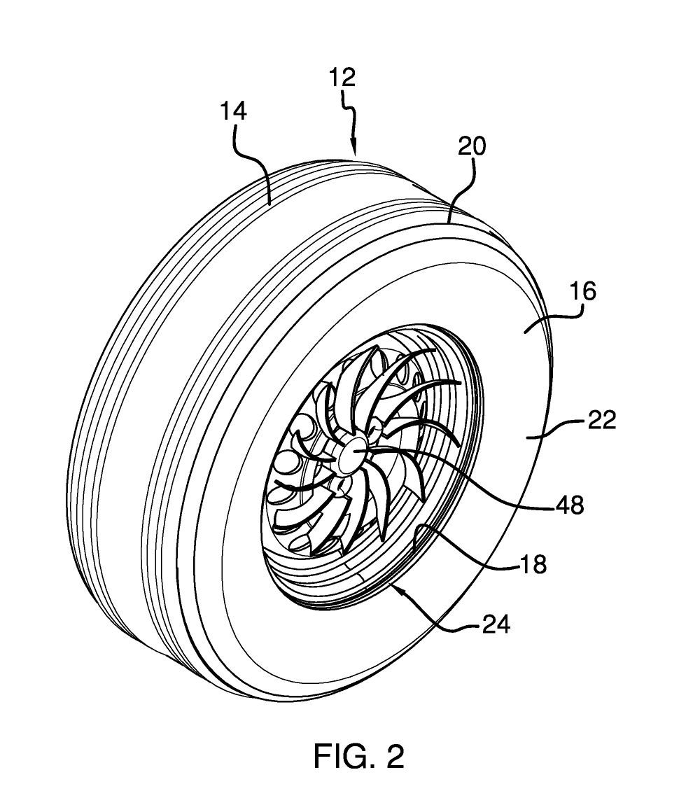

In an alternative embodiment as shown in FIG. 2, the vanes 34 may be coupled to the wheel 26. The vanes 34 may be positioned within the opening 24 in the tire 12. The vanes 34 may be distributed around an entire circumference of the wheel 26. The first end 36 may be positioned adjacent to the inner edge 18. The second end 38 may be positioned adjacent to a hub 48 of the wheel 26.

In use, the vanes 34 increase a service life of the tire 12 by reducing the amount of friction on the outer wall 14 of the tire 12 when the aircraft 32 lands. Additionally, the rotation of the tire 12 prior to landing the aircraft 32 facilitates a greater control of the aircraft 32 upon landing. The tire 12 is replaced in accordance with aircraft tire maintenance standards.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tire spinning assembly configured to rotate a tire on an aircraft landing gear before the tire engages ground, said assembly comprising:
a tire configured to be coupled to landing gear of an aircraft; and
a plurality of vanes coupled to said tire, said vanes being configured to be frictionally engaged by air when the landing gear are deployed thereby rotating said tire, said vanes being oriented such that said tire is configured to be rotated in a direction and a speed corresponding to a direction and a speed traveled by the aircraft thereby reducing an amount of friction between said outer wall and ground when the aircraft lands.

2. The assembly according to claim 1, wherein said tire having an outer wall and a peripheral wall extending inwardly therefrom, said peripheral wall having an inner edge, an outer edge and a first lateral side extending therebetween, said first lateral side being exposed with respect to the landing gear.

3. The assembly according to claim 2, wherein each of said vanes having a first end, a second end, a front surface and a back surface each extending between said first end and said second end, said vanes each having a first lateral edge and a second lateral edge, said first end having a height being greater than a height of said second end, said first lateral edge being coupled to said first lateral side.

4. The assembly according to claim 3, wherein said first end being positioned adjacent to said outer edge, said second end being positioned adjacent to said inner edge, said vanes being distributed around said first lateral side, said front surface and said back surface being convexly curvilinear between said first end and said second end.

5. A tire spinning assembly configured to rotate a tire on an aircraft landing gear before the tire engages ground, said assembly comprising:
a tire having an outer wall and a peripheral wall extending inwardly therefrom, said peripheral wall having an inner edge, an outer edge and a first lateral side extending therebetween, said tire being configured to be coupled to landing gear of an aircraft having said first lateral side being exposed with respect to the landing gear; and
a plurality of vanes each having a first end, a second end, a front surface and a back surface each extending between said first end and said second end, said vanes each having a first lateral edge and a second lateral edge, said first end having a height being greater than a height of said second end, said first lateral edge being coupled to said first lateral side, said first end being positioned adjacent to said outer edge, said second end being positioned adjacent to said inner edge, said vanes being distributed around said first lateral side, said front surface and said back surface being convexly curvilinear between said first end and said second end, said vanes being configured to be frictionally engaged by air when the landing gear are deployed thereby rotating said tire, said vanes being oriented such that said tire is configured to be rotated in a direction and a speed corresponding to a direction and a speed traveled by the aircraft thereby reducing an amount of friction between said outer wall and ground when the aircraft lands.
